(19) United States
(12) Patent Application Publication
(10) Pub. No.: US 2020/0340442 A1
(43) Pub. Date: Oct. 29, 2020

(54) A SYSTEM FOR GENERATING ELECTRICITY FROM AIR HYDROPOWER

(71) Applicant: SANDIP PRALHAD GADE, MUMBAI (IN)

(72) Inventor: SANDIP PRALHAD GADE, MUMBAI (IN)

(21) Appl. No.: 16/760,450

(22) PCT Filed: Dec. 14, 2018
(86) PCT No.: PCT/IB2018/060088

§ 371 Date: Apr. 30, 2020

(30) Foreign Application Priority Data
Dec. 18, 2017 (IN) 201721045318

(51) Int. Cl. F03B 13/08; H02K 7/116; H02K 7/18; F03B 3/00; F03B 11/00

(52) U.S. Cl. CPC F03B 13/08; H02K 7/116; F03B 11/002; F03B 3/00; H02K 7/1823

(57) ABSTRACT

The present invention provides of a system for generating electricity from air hydropower. The system is having a pump from a reservoir. Also, at least one vessel for receiving pumped water therein, the at least one vessel having a pressure plate being buoyant over the water and pressurized pneumatically from other side to increase pressure over the water. The pressurized water is automised and released over the turbine for generating electricity. The system has an advantage of having less construction and maintenance cost by using very small area. Further, the system has an advantage of being converted from thermal power to air hydro power plant.

### TECHNICAL FIELD

The present invention relates to a system for generating electricity from air hydropower. More particularly, the present invention relates to a system for generating electricity using renewable energy.

### BACKGROUND

Generally, dams are specifically made for hydroelectricity generation. A hydro electricity generator used for the generation of hydroelectricity may produce air pollutants, thereby affecting environment. There are many environmental consequences that occurred from the use of hydroelectric generator. The dam and a reservoir may obstruct fish migration in a way that the fish habitats are shaped by physical factors such as water level, water velocity and shelter opportunities and access to food. Draining would be completely destructive to the fish. Beyond this, the amount of water may have different effects on the fish in a river, depending on the type and stage of the lifecycle. The dam and the reservoir can also change natural water temperatures, water chemistry, river flow characteristics, and silt loads. These changes may have negative impacts on animals in and around the river. Also, the crisis of water in the river and dams lead to generate less hydroelectricity.

Further, greenhouse gases like carbon dioxide and methane may also form in the reservoirs which can be emitted to the atmosphere. The exact amount of greenhouse gases produced in hydroelectric reservoirs is uncertain. Moreover, the hydroelectric power plants are expensive to construct and require very large area for power plant.

There is no such hydroelectric power system as on date which is able to succeed in dealing with the ongoing problems.

Therefore, there is a need to provide a system which can overcome the limitation and drawbacks of existing system.

### OBJECTS OF THE INVENTION

An object of the present invention is to provide a system for generating electricity from air hydropower.

Another object of the present invention is to provide a system for generating electricity from air hydropower, which causes no air pollution, thereby protecting environment.

Yet another object of the present invention is to provide a system for generating electricity from air hydropower, which requires very less space for the production of large amount of power.

Further object of the present invention is to provide a system for generating electricity from air hydropower, which can produce constant power in all seasons.

Further one object of the present invention is to provide a system for generating electricity from air hydropower having less construction and maintenance cost by using very small area.

One more object of the present invention is to provide a system for generating electricity from air hydropower, which has high efficiency.

Further object of the present invention is to a system for generating electricity from air hydropower, which converts thermal power to air hydro power plant.

Another object of the present invention is to provide a system for generating electricity from air hydropower, which is simple and economical in operation.

Yet another object of the present invention is to provide a system for generating electricity from air hydropower, which is robust in operation.

### SUMMARY OF THE INVENTION

According to the present invention, there is provided a system for generating electricity from air hydro power. The system is having a pump for pumping water from a reservoir. Also, at least one vessel for receiving pumped water therein, the at least one vessel having a pressure plate being buoyant over the water and pressurized pneumatically from other side to increase pressure over the water. The pressurized water is being automised and released over the turbine for generating electricity. The pneumatic pressure on the pressure plate is applied by using pressurized air from an air fodder (hydraulic air fodder). Also, an air compressor unit connected with the automisation unit for automising water before releasing the water over the turbine. Further, the pressurized water from the at least one vessel is released over the turbine through a penstock. Also, the turbine is having a turbine bucket, an air duct and a perforated plate. The compressed air is passed through the air duct and is mixed with the water through the perforated plate. Furthermore, a gear box is used between the turbine and the generator for increasing the rpm. Moreover, a step-up transformer is used for transferring the electricity to a grid.

### BRIEF DESCRIPTION OF DRAWINGS

FIG. 1 shows a diagram of a system for generating electricity from hydro power in accordance with the present invention;

FIG. 2 shows a diagram of a pressure plate inside the vessel in accordance with the present invention;

FIG. 3 shows a sectional view of a piston in accordance with the present invention; and

FIG. 4 shows a portion of a turbine for generating electricity from hydro power in accordance with the present invention in accordance with the present invention.

### DETAILED DESCRIPTION OF THE INVENTION

An embodiment of this invention, illustrating its features, will now be described in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The terms ‘first,_ ‘second,_ and the like, herein do not denote any order, quantity, or importance, but rather are used to distinguish one element from another, and the terms ‘a_ and ‘an_ herein do not denote a limitation of quantity, but rather denote the presence of at least one of the referenced item.

The present invention provides a system for generating electricity from hydropower. The system cause no air pollution, thereby protecting environment. Also, the system requires very less space for the production of large amount of electricity. The system can produce constant electricity in all seasons. The system is having less construction and maintenance cost by using very small area. Further, the system is having high efficiency. Also, the system converts thermal power to air hydro power plant. Furthermore, the system is simple and economical in operation. Moreover, the system is robust in operation.

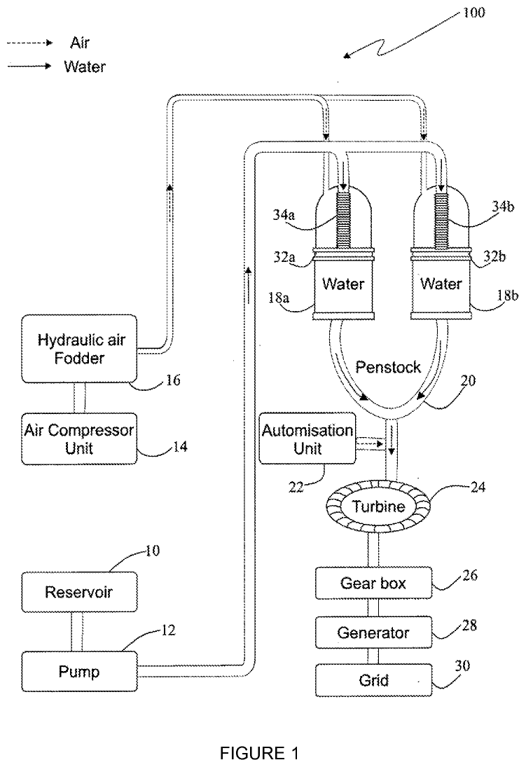

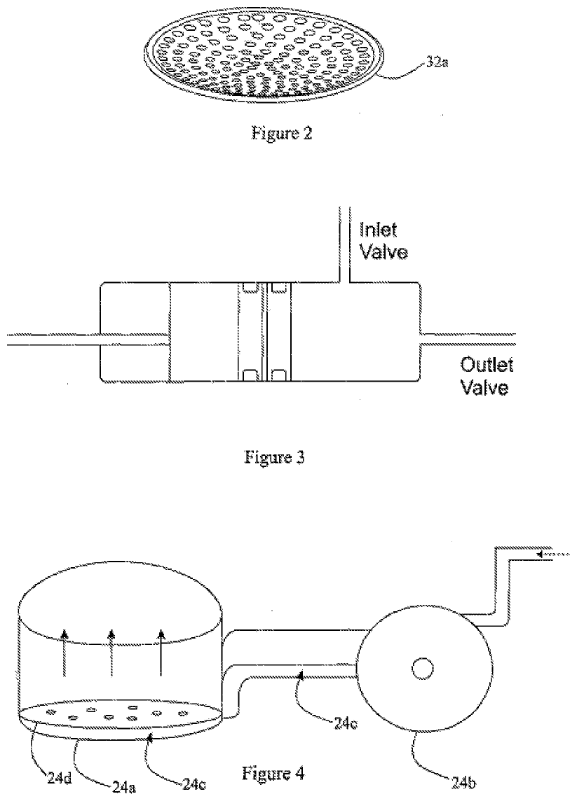

Referring now to FIG. 1, diagram of a system 100 for generating electricity from hydropower in accordance with the present invention is illustrated. The system 100 includes a reservoir 10, a pump 12, an air compression unit 14 for providing air to an air fodder 16. In the present embodiment, the air fodder 16 is a hydraulic air fodder. Also, the system 100 includes two vessels 18a and 18b. The vessels 18a and 18b includes pressure plates 32a and 32b. The pressure plate 32a of the vessel 18a is shown in FIG. 2. In the present embodiment, the system 100 includes a penstock 20 and an automisation unit 22, which rel eases water and air to a turbine 24 respectively. Further, the system 100 includes a gear box 26 to increase the rpm. Also, the system 100 includes a generator 28 and a grid 30 for delivering the electricity to the distribution line.

In the present invention, the pump 12 for pumping water from the reservoir 10, at least one vessel, (in the present embodiment two vessels 18a and 18b are shown) is used for receiving pumped water therein. The vessels 18a and 18b have the pressure plates 32a and 32b being buoyant over the water and pressurized pneumatically from other side to increase pressure over the water, the pressurized water is automised and released over the turbine 24 for generating electricity. Also, the pneumatic pressure on the pressure plates 32a and 32b is applied by using pressurized air from the air fodder 16. Further, the air compression unit (not shown) is connected with the automisation unit 22 for automising water before releasing the water over the turbine 24. In the present embodiment, the pressurized water from the vessels 18a and 18b is released over the turbine 24 by the penstock 20. Furthermore, the gear box 26 is used between the turbine 24 and the generator 28 for increasing the rpm. The step-up transformer is used for transferring the electricity to the grid 30.

The pump 12 pumps the water from the reservoir 10. The pump 12 is fitted below the reservoir 10. A piston inside the cylinder (not shown) is connected to the pump 12. The assembly of the cylinder and the pump 12 injects the water from the reservoir 10 with inlet valve opened and outlet valve closed (shown in FIG. 3). The piston moves to and fro, thereby opening an outlet valve and releasing the water to the vessels 18a and 18b. The water reaches to the vessels 18a and 18b through a water bellows 34a and 34b respectively. The inlet valve is closed when the water is released to the vessels 18a and 18b.

In the present embodiment, the air compressor unit 14 provides air to the air fodder 16 for compressing the air to 300 bar pressure. The compressed air then passes to the vessels 18a and 18b. The compressed air and the water pumped from the reservoir 10 together presses the pressure plates 32a and 32b with high pressure and vice-versa. Due to pressure applied on the pressure plates 32a and 32b, the water moves down with very high speed through the penstock 20 and released with very high torque and high pressure on the turbine 24. The length of the penstock 20 is 50 meter.

Also, the air compressor unit (not shown) is connected to the automisation unit 22 for automising water before releasing the water over a turbine bucket 24a of the turbine 24 as shown in FIG. 4. The mixture of pressurized air and water is released through an air duct 24c over the blades of turbine bucket 24a, thereby moving the turbine 24 with high speed (refer example). Specifically, the compressed air is passed through the air duct 24c and is mixed with the water through a perforated plate 24d. Further, the gear box 26 is connected between the turbine 24 and generator 28 for increasing the rotational speed of a rotor of the turbine 24 to the desired rpm of the generator 28, thereby generating electricity. Also, the generated electricity is transferred to the grid 30 through a step-up transformer (not shown). The left over water again get saved in the reservoir 10 for the next process.

For Example:—Water pressure converted into head in meter. Converting pressure into bar to head (M).

h=P×10.197/SG
h=head (M)
SG=Specific gravity.
Pressure for production in the vessel=300 bar.

h=P*10.197/SG

h=300×10.197/SG
h=3059.1 meter.
Add accelerating downward motion head=50 meter.

Total head=3059.1+50=3109.1 meter
For power generation from hydro power

P=npQgh
where,
P=power in watts.
n=dimensionless efficiency of the turbine.
p=density of water in kilograms per cubic meter.
Q=flow in cubic, meters per second.
g=acceleration due to gravity.
h=height difference between inlet and outlet in the meters as head.
Efficiency of turbine is 85% with water at 1000 kg/cubic meter, and flow rate 4 cubic meters/second.
Gravity of 9.81 meters per second square and with a net head of 3109.1 meter.

P=npQgh

Power (W)=0.85×1000×4×9.81×3101
Power=103,430,754 watt
Power=103.43 MW

Efficiency of generating power with the technology of air hydropower it makes more with the air pressure turbine 24, air drop and adding system in the penstock 20 and due to gear box 26 for converting low to high rpm. [0028] Therefore, the present invention provides the advantage of a system 100 for generating electricity from air hydropower. The system 100 causes no air pollution, thereby protecting environment. Also, the system 100 requires less space for the production of large amount of electricity. The system 100 can produce constant electricity in all seasons. The system 100 is having less construction and maintenance cost. Further, the system 100 is having high efficiency. Also, the system 100 converts thermal power to air hydro power plant. Furthermore, the system 100 is simple and economical in operation. Moreover, the system 100 is robust in operation.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

I claim:

1. A system for generating electricity from air hydropower, the said system comprising:
a pump for pumping water from a reservoir; and
at least one vessel for receiving pumped water therein, the at least one vessel having a pressure plate being buoyant over the water and pressurized pneumatically from other side to increase pressure over the water, wherein the pressurized water is automised and released over the turbine for generating electricity.

2. The system as claimed in claim 1, wherein the pneumatic pressure on the pressure plate is applied by using pressurized air from an air fodder.

3. The system as claimed in claim 1, wherein an air compressor unit is connected with an automisation unit for automising water before releasing the water over the turbine.

4. The system as claimed in claim 1, wherein the turbine having a turbine bucket, an air duct and a perforated plate, wherein, the compressed air is passed through the air duct and is mixed with the water through the perforated plate.

5. The system as claimed in claim 1, wherein the pressurized water from the at least one vessel is released over the turbine by a penstock.

6. The system as claimed in claim 1, wherein a gear box is used between the turbine and the generator for increasing the rpm.

7. The system as claimed in claim 1, wherein a step-up transformer is used for transferring the electricity to a grid.
